(19) United States
(12) Patent Application Publication
(10) Pub. No.: US 2017/0124997 A1
(43) Pub. Date: May 4, 2017

(54) ELECTRONIC MUSICAL INSTRUMENT SYSTEM AND EFFECTS MODULE FOR SUCH A MUSICAL INSTRUMENT SYSTEM

(71) Applicant: Ampete Engineering GbR, Cologne (DE)

(72) Inventors: Sebastian BLASCHKE, Cologne (DE); Peter ARENDS, Cologne (DE)

(21) Appl. No.: 14/946,919

(22) Filed: Nov. 20, 2015

(30) Foreign Application Priority Data
Oct. 30, 2015 (DE) 10 2015 118 583.0

(51) Int. Cl. G10H 1/00; G10H 1/34

(52) U.S. Cl. CPC G10H 1/0033; G10H 1/348; G10H 1/0091; G10H 1/0066; G10H 2240/281; G10H 2230/035; G10H 2210/155; G10H 2220/071

(57) ABSTRACT

The invention relates to an electronic musical instrument system (1) for influencing the sound of an electric musical instrument having a housing (2) that has signal ports (14, 18) and a power supply port (15). In order to simplify the individual combination of different audio effects, the housing (2) contains control electronics (6) that have associated slots (4a-4f) for effects modules (19), wherein the slots (4a-4f) are arranged in the housing (2) and each slot (4a-4f) has a multipin connection (5a-5f) for connection to a plug-in effects module (19). The invention additionally relates to a corresponding effects module (19).

The invention relates to an electronic musical instrument system for influencing the sound of an electric musical instrument having a housing that has signal ports and a power supply port.

By way of example, an electric musical instrument system of this kind is used for producing audio effects for a musical instrument, such as an electric guitar, whose sound is electrically amplified. So as then to influence the amplified sound of the guitar and hence individualize the “voice” of the musician, a plurality of what are known as effects units are usually combined with one another according to the prior art.

In this case, each of the effects units produces an effect of its own, for example additional gain, distortion, tremolo, echo, a reverb effect or the like. Depending on the desired effect, the corresponding effects units are then activated. This results in significant corn-plexity in terms of cables and plug connections and also a relatively great space requirement, which is frequently available only to a limited degree on a stage, for example.

In addition, the interconnection of different electronic effects units can result in tone and signal losses and undesirable background noise. To prevent this, the prior art requires each effects unit to have specifically attuned power supply units and circuits that further complicate the setup.

The invention is now based on the object of providing an electronic musical instrument system that makes the complexity for providing different effects as simple as possible.

The invention achieves this object by means of an electronic musical instrument system having the features of claim 1. Advantageous embodiments can be found in the sub-claims.

In an electronic musical instrument system for influencing the sound of an electric musical instrument having a housing that has signal ports and a power supply port, the invention provides for the housing to contain control electronics that have associated slots for effects modules, wherein the slots are arranged in the housing and each slot has a multipin connection for connection to a plug-in effects module, the multipin connection being used at least for signal transmission and for supplying an operating voltage.

The housing of the electronic musical instrument system therefore provides the effects modules not only with mechanical retention but also with an electronic connection for the signal ports and a power supply port. The effects modules can then be selected according to the desired effect for influencing an audio signal coming from the musical instrument and inserted into the housing. The effects modules themselves then require no housing, switches, sockets and the like of their own, but rather essentially need to have only the electronics for the desired effect. The tone and signal losses and background noise that frequently arise when different effects units are combined according to the prior art are avoided by the control electronics of the electronic musical instrument system, which are used for all effects modules jointly.

In this case, the electronic musical instrument system according to the invention provides an individualizable and modularly extendable musical instrument system, with a wide variety of audio effects being able to be provided and combined by selecting ap-propriate effects modules. In comparison with the individual effects units used to date, the result in this case is a very much simpler setup with minimization of possible sources of error.

In this case, the multipin connection can provide particularly not only different operating voltages, such as 9 or 30 volts DC or 12 volts AC, but also a plurality of ports for a refer-ence-ground potential, various audio inputs and outputs in mono and/or stereo, various direct access options for the respectively connected effects module, a function for controlling the tempo of effects, a control function for influencing parameters of the effects module, a MIDI interface and the like.

Effects modules in a wide variety of embodiments can thus be combined within the electronic musical instrument system, with all or else just selected instances of the functions provided by means of the multipin connection in conjunction with the control electronics being used. Not all the slots need to be occupied in this case, but rather any occupancy of the slots is possible, individual slots also being able to remain unused. In particular, this allows arbitrary selection of an order for the effects modules that are held.

The slots are particularly arranged parallel next to one another on a board that has the control electronics. In this case, the board may be arranged on a base of the housing, so that there is sufficient space available above the board for accommodating the effects modules within the housing. In this case, the signal ports and/or the power supply port may also be mounted on the board, so that the required electrical connections can be produced on the board without interference. It is therefore also possible for the musical instrument system to be produced inexpensively, since the required ports and connections can be put onto the board in one work step, said board then being inserted into the housing.

A parallel arrangement of the slots next to one another allows the effects modules to be arranged in the housing in a space-saving manner. In this case, the slots are particularly oriented parallel to a narrow side of the housing, so that a plurality of effects modules can be arranged next to one another in the longitudinal direction of the housing. Depending on the length of the housing, it is then possible for more or fewer slots to be provided.

In one preferred embodiment, the control electronics have a computation unit, at least one memory and a programming interface. The control electronics can thus be used to control and possibly also program the effects modules that are held in the slots. In particular, the control electronics can be used in this case to assign the signal ports to individual effects modules. It is also possible for the control electronics likewise to provide individual effects for influencing the sound.

In this case, it is particularly preferred for the control electronics to have an input amplifier. This can produce a signal gain in addition to an external unit, such as a guitar amplifier.

The control electronics can also provide further functions, for example a function for controlling time-based effects or for muting individual signal outputs and also a digital interface for musical instruments (MIDI). The control electronics can also be used to provide ports for external units, such as a control pedal.

The housing advantageously has, above the slots, an opening that can be closed particularly by cover elements arranged next to one another, each slot having an associated cover element. In this case, the opening extends over all the slots, with removal of an individual cover element allowing individual access to the respective slot, so that an effects module can be inserted without any problems.

Preferably, at least one effects module is arranged in at least one of the slots, which effects module is in the form of a preamplifier, distorter, tremolo, phaser, chorus, flanger, echo, reverb or the like. The effects module therefore provides at least one of the frequently used audio effects for an electronic musical instrument connected to the musical instrument system, such as an electric guitar. In this case, the musical instrument can also be connected to the musical instrument system via an amplifier. Usually, however, an amplifier is connected downstream of the musical instrument system.

Preferably, a plurality of effects modules are accommodated in the musical instrument system that provide different audio effects.

In one preferred embodiment, the effects module has a plug-in card on which electrical components and circuits are arranged. The electronic components of the effects module can therefore likewise be accommodated on a board, alternatively a “Printed Circuit Board” (PCB), and thus be produced using standard methods. In this case, the effects modules require only relatively little installation space.

Preferably, each of the cover elements has an associated effects module in this case, with the cover element covering the effects module inserted in the housing. The effects module is then formed by the plug-in card and the cover element permanently connected thereto. When slots are empty, the cover elements originally covering the opening can remain, said cover elements being of relatively simple design. When an effects module is inserted, they are replaced by the cover element connected to the effects module. Just from the externally visible cover element that represents part of the effects module and that is inserted with the effects module it is then frequently possible to tell which effects module has been accommodated in the housing.

In this case, the cover element is preferably used for additional mounting of the effects module. For this purpose, the cover element may be mountable, particularly latchable, on the housing. It is also envisaged that the cover element will be screwed to the housing by means of additional screw elements, with corresponding guide rails additionally being able to be provided in the housing.

In one preferred development, the cover element has a user interface that can be used to influence the effects module. By way of example, this is potentiometers or switches that influence the effect that can be achieved with the effects module and are connected directly to the electronics situated on the plug-in card of the effects module. Following insertion of the effects module, it is then normally already operational.

Preferably, each cover element has associated lighting for indicating activity by the effects module. In this case, this lighting is preferably arranged on the housing above the slot, with arrangement on the cover element of the effects module also being an alterna-tive option. This allows primarily a status of an effects module and the like to be indicated. In this case, this lighting is formed by one or more multicolored LEDs, for example, and may be arranged behind a transparent cover, for example, such as a pane.

Preferably, the housing, particularly a top of the housing, has operator control elements such as foot switches arranged on it, with particularly each slot having an associated operator control element. This allows very simple operator control of the musical instrument system, with—particularly when foot switches are used—operator control also being possible almost blind while playing the musical instrument. If need be, each operator control element may also have associated lighting of its own, particularly LEDs, in order to indicate a status.

In this case, the operator control elements or foot switches can have different operator control levels, with an initial level allowing preset programs, what are known as presets, to be retrieved, for example, and further levels allowing different direct access operations and/or routing options to be selected.

In a preferred development, the effects modules inserted can, for this purpose, be individually activated, particularly controlled, using the operator control elements. In this case, individual operator control elements can, if need be, also be used to program the control electronics.

To simplify operator control, a top of the housing can have indicator elements arranged on it that can be actuated by means of the control electronics. By way of example, the indicator elements are differently colored LEDs or a seven-segment display. This allows extended programming. Alternatively, it is possible for operating states of the musical instrument system or of the effects modules to be indicated.

The object cited at the outset is also achieved by an effects module for a musical instrument system as described above that has a plug-in card that has a contact strip for introduction into a multipin connection of the musical instrument system. In this case, the plug-in card is particularly what is known as a “printed circuit board” having circuits and electronic chips fitted. These are compiled according to the desired effect and can be actuated directly and/or via the board of the musical instrument system.

In this case, particularly provision is made for the contact strip to have a plurality of contacts, the contacts being situated particularly on opposite sides of the contact strip. This allows many connections to be produced in a relatively tight space.

Preferably, 15 contacts are provided per side of the contact strip, that is to say a total of 30 contacts. Hence, a sufficient number of connection options are available in order to transmit stereo audio signals, different control signals, different operating voltages and a plurality of reference-ground potentials.

In this case, it is particularly preferred for the same operating voltages to be applied to each of two contacts situated next to one another, with at least one contact for a refer-ence-ground potential being provided beside these contacts. The use of two contacts for an operating voltage allows relatively high powers to be transmitted, with interference being kept down as a result of reference-ground potentials arranged next to them.

The contacts of the contact strip are used preferably for transmitting operating voltages, reference-ground potentials, audio signals, control signals and MIDI signals. This allows complete incorporation of and supply of power to the effects module within the musical instrument system, with no further additional electrical connections needing to be produced. In this case, control signals from externally connected input units, such as a foot pedal, can also be transmitted via corresponding contacts of the multipin connection.

In a particularly preferred embodiment, a side of the plug-in card that is opposite the contact strip has a cover element mounted on it that can be used to immobilize the effects module in a housing of the musical instrument system. The cover element replaces the original cover element of the musical instrument system and firstly ensures that the effects module is held securely within the housing, but can also provide additional operator control elements that are attuned to the electronics of the plug-in card.

The effects module may also be embodied such that it has more than one contact strip and hence occupies more than one slot. This means that the effects module can be produced much larger, that is to say can have more or larger electrical components and at the same time be mounted robustly.

The invention is described in more detail below using a preferred exemplary embodiment in conjunction with the figures, in which:

FIG. 1 shows a musical instrument system with an open housing,

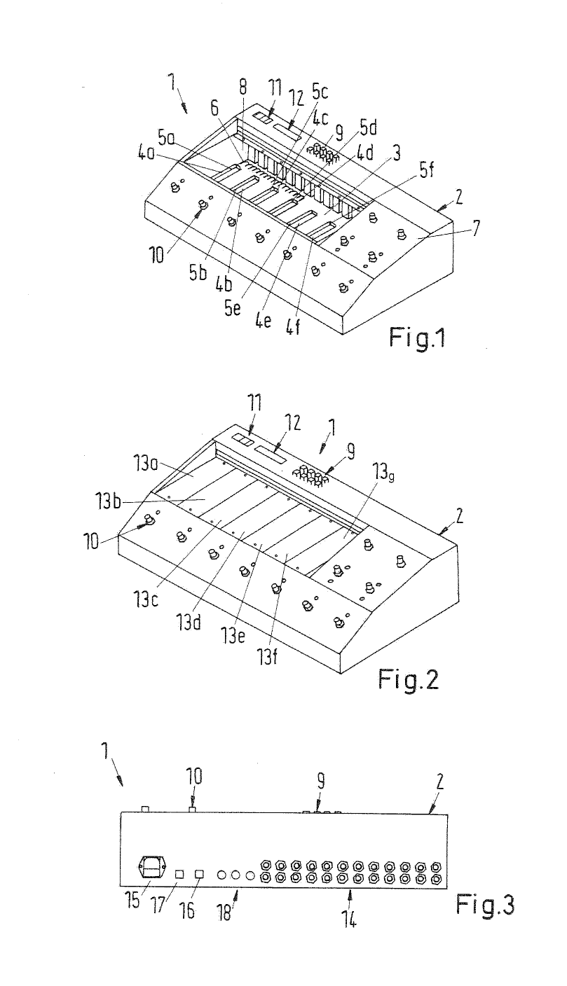

FIG. 2 shows the musical instrument system with cover elements inserted,

FIG. 3 shows a rear of the musical instrument system,

FIG. 4 shows a side view of an effects module,

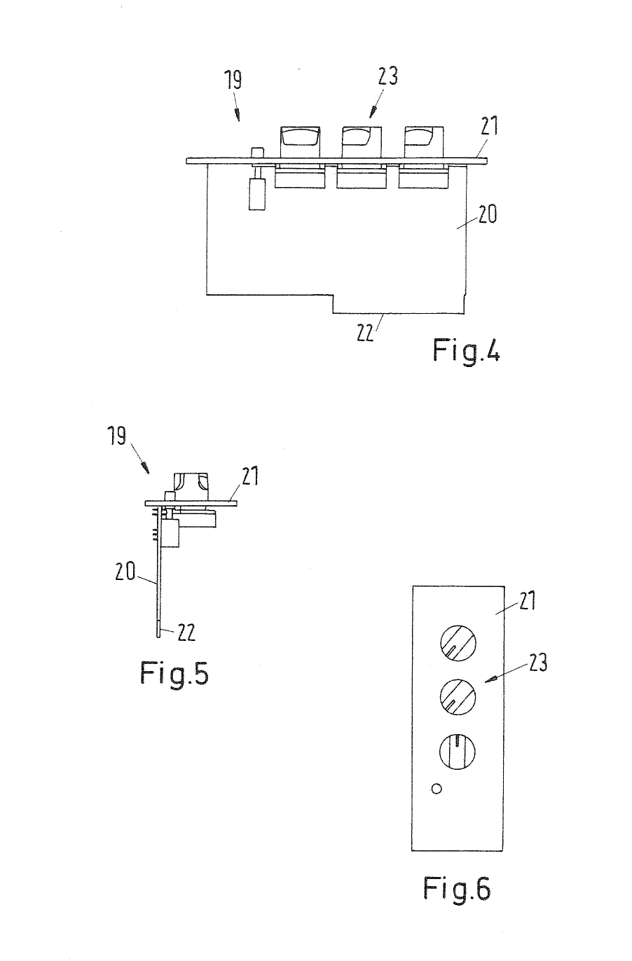

FIG. 5 shows a front view of an effects module and

FIG. 6 shows an effects module from above.

FIG. 1 shows a three-dimensional view of a musical instrument system 1 with a housing 2. Arranged within the housing 1 is a board 3 that provides an array of slots 4a-4f. Of the total of seven slots in this exemplary embodiment, the perspective of the representation allows only the six slots 4a-4f to be seen. In this case, each slot 4a-4f has an associated multipin connection 5a-5f, in particular the multipin connection 5a-5f is integrated in the slots 4a-4f in this case.

There is additionally a symbolic representation of control electronics 6 that are produced on the board 3. These are what is known as an integrated circuit, which has been put onto the board 3 by means of known surface mounting techniques, for example.

A top 7 of the housing 2 has an opening 8 produced in it that is situated above the slots 4a-4f arranged parallel to one another. This opening 8 allows effects modules to be inserted into the slots 4a to 4f without any problems.

In addition, the top 7 of the housing 2 has various operator control elements 9, 10 on it, of which the operator control elements 9 are used as keys for manual input while the operator control elements 10 are in the form of foot switches. In this case, each slot 4a-4f has at least one associated operator control element 10. The operator control elements 9 and foot switches 10 can have different control levels in this case in order to allow variable uses and/or access operations.

Arranged on the top 7 of the housing 2 is a seven-segment display 11 and a status bar 12 with differently colored LEDs. Alternatively or additionally, other indicator elements, particularly color displays, can also be provided.

FIG. 2 shows the musical instrument system 1 shown in FIG. 1 with the opening 8 closed. An array of cover elements 13a-13g are arranged next to one another, in each case above one of the slots 4a-4f, so that the opening 8 is completely closed. In this case, the cover elements 13a-13g can be individually removed and replaced by a cover element connected to an effects module. The cover elements 13a-13g shown in FIG. 2 are used in this case to protect the interior of the housing 2 from dirt and damage when there are not yet any effects modules inserted or when slots are still free. In this exemplary embodiment, the cover elements 13a-13g are screwed to the housing 2, that is to say detachably mounted and replaced by the cover element of the respective effects module when the effects modules are inserted.

FIG. 3 shows a rear of the musical instrument system 1. This is the location for signal ports 14, with at least two signal ports being associated with each slot. These are particularly ports for control signals and/or inputs and outputs for audio signals. In addition, there is a power supply port 15 on the rear of the housing 2, which power supply port can be connected to a public grid, for example. Conversion into the currents and voltages required for the effects modules then takes place within the musical instrument system, said currents and voltages then being made available to the respective effects module via the multipin connections 5a to 5f.

The musical instrument system 1 can furthermore provide further interfaces, for example a MIDI interface 16, 18, and a USB port 17.

FIG. 4 schematically shows an effects module 19 that has a plug-in card 20 with electronic components arranged thereon for producing the desired effect, and also a cover element 21 that is permanently connected to the plug-in card 20. In this case, the plug-in card 20 can have its port region 22 plugged into one of the slots 4a-4f to set up a connection to the multipin connection 5a-5f. In this case, the effects module 19 is additionally mounted on the housing 2 by means of the cover element 21.

The cover element 21 has various user interfaces 23 mounted on it for controlling the effects module 19. By way of example, these are potentiometers and the like.

FIG. 5 shows a side view of the effects module 19. This figure clearly shows that a dedicated housing is dispensed with, since the effects module is held within the housing 2 of the musical instrument system 1 and is then protected from external influences by the closure of the opening that is required for insertion by means of the cover element 21.

FIG. 6 shows a plan view of the effects module with the operator control elements 23 that are freely accessible from above.

The musical instrument system according to the invention is used for accommodating and connecting up various effects modules that can be used to produce different audio effects for electric musical instruments. In particular, the musical instrument system is in this case used for holding effects modules for electric guitars, such as preamplifiers, dis-torters and the like. In this case, the effects modules are characterized by a standard plug-in card format. Control electronics that are permanently installed within the musical instrument system are then used to provide all the required signal and power supply ports. In this case, the required ports are also produced in the housing. The effects modules then need to have only the electronics that are required for the respective effect.

In this case, the signal ports comprise both control ports and signal ports for audio signals. In particular, in this case two signal inputs and two signal outputs are provided, which allow stereo operation, but can also be used as dual mono ports in order to allow switching between different amplifier inputs. At least one of these signal outputs can also have an associated connectable 180° phase rotation in this case. Possibly additionally, a symmetrical output with speaker simulation and/or an equalizer may also be provided. At least some of the signal ports of the housing may in this case be equipped with switcha-ble stereo jack sockets that can be used to achieve switching states, such as channel changeover, on external units.

If need be, it is also possible for the multipin connection to be used to provide different connection and control options for influencing individual parameters. By way of example, it is thus possible to synchronize individual effects modules to one another or to apply an effect provided by the control electronics synchronously.

A preferred and advantageous embodiment of the multipin connection is achieved by virtue of double-sided contact connection that provides a total of 30 contacts, with a corresponding number of contacts being provided in the contact strip of the effects module. In this case, the assignment has the following appearance, in particular:

| Con- | | | |
|---|---|---|---|
| tact | | Contact | |
| No. | One side | No. | Opposite side |
| 1 | Audio input L | 16 | Audio output L |
| 2 | Audio input R | 17 | Audio output R |
| 3 | Reference-ground potential | 18 | Reference-ground potential |
| 4 | External control Signal in | 19 | External control signal out |
| 5 | External control signal | 20 | Reference-ground potential |
| 6 | +9 V DC | 21 | +30 V DC |
| 7 | +9 V DC | 22 | +30 V DC |
| 8 | Reference-ground potential | 23 | Reference-ground potential |
| 9 | Control signal (TAP) | 24 | MIDI signal |
| 10 | Functional port | 25 | MIDI signal |
| 11 | Reference-ground potential | 26 | Reference-ground potential |
| 12 | Reference-ground potential | 27 | Reference-ground potential |
| 13 | Reference-ground potential | 28 | Reference-ground potential |
| 14 | 12 V AC | 29 | 12 V AC |
| 15 | 12 V AC | 30 | 12 V AC |

Such assignment allows relatively high powers to be transmitted, with interference in the signals, for example as a result of feedback, being largely avoided. At the same time, the multipin connection of the slot and the contact strip provides all the required connections for insertion of the effects modules, external input units also not needing to be connected directly to the effects module, but rather being able to be connected to the relevant ports of the housing.

The invention is not limited to one of the exemplary embodiments shown above. By way of example, it is thus possible for the form of the housing to differ from the shape shown. It is also possible for more or fewer slots to be provided for more or fewer effects modules. In this case, the control electronics can also already provide individual effects, so that frequently used effects are preinstalled and only additional effects need to be added by means of the effects modules. By way of example, a tuner, loudspeaker simulation and an equalizer are integrated, while further effects are added by corresponding effects modules. In this case, the effects modules can be combined with one another relatively freely, so that the musical instrument system can easily be individualized for the desired purposes. In comparison with the conventional approach, in which a multiplicity of standalone effects units are connected up to one another, this results in lower interconnection complexity, low susceptibility to interference and reduced space requirement.

### LIST OF REFERENCE SYMBOLS

1 Musical instrument system
2 Housing
3 Board
4a-4f Slots
5a-5f Multipin connection
6 Control electronics
7 Top
8 Opening
9 Operator control element
10 Operator control element
11 Seven-segment display
12 Status indicator
13a-g Cover elements
14 Signal and control ports
15 Power supply port
16 MIDI interface
17 USB interface
18 MIDI interface
19 Effects module
20 Plug-in card
21 Cover element
22 Port region
23 User interface

1. An electronic musical instrument system (1) for influencing the sound of an electric musical instrument having a housing (2) that has signal ports (14, 18) and a power supply port (15), wherein the housing (2) contains control electronics (6) that have associated slots (4a-4f) for effects modules (19), wherein the slots (4a-4f) are arranged in the housing (2) and each slot (4a-4f) has a multipin connection (5a-5f) for connection to a plug-in effects module (19), the multipin connection (5a-5f) being used at least for signal transmission and for supplying an operating voltage, and wherein the control electronics (6) have a computational unit, at least one memory, and a programming interface (16).

2. The musical instrument system as claimed in claim 1, wherein the slots (4a-4f) are particularly arranged parallel next to one another on a board (3) that has the control electronics (6).

3. (canceled)

4. The musical instrument system as claimed in claim 1, wherein the control electronics (6) have an input amplifier.

5. The musical instrument system as claimed in claim 1, wherein the housing (2) has, above the slots (4a-4f), an opening (8) that can be closed particularly by cover elements (13a-13g), each slot (4a-4f) having an associated cover element (13a-13g).

6. The musical instrument system as claimed in claim 1, wherein at least one effects module (19) is arranged in one of the slots (4a-4f), the effects module (19) being in the form of a preamplifier, distorter, tremolo, phaser, chorus, flanger, echo, reverb or the like.

7. The musical instrument system as claimed in claim 5, wherein the effects module (19) has a plug-in card (20) on which electrical components and circuits are arranged.

8. The musical instrument system as claimed in claim 5, wherein each of the cover elements (13a-13g) is associated with an effects module (19), the cover element (13a-13g) partially covering the opening (8) in the housing (2) when an effects module is inserted.

9. The musical instrument system as claimed in claim 5, wherein the cover element (13a-13g) is mountable, particularly latchable, on the housing (2).

10. The musical instrument system as claimed in claim 5, wherein the cover element (13a-13g) has a user interface (23) that can be used to influence the effects module (19).

11. The musical instrument system as claimed in claim 5, wherein each slot (4a-4f) has an associated lighting device for indicating activity by the effects module (19), which lighting device is particularly arranged in the housing (2).

12. The musical instrument system as claimed in claim 1, wherein the housing (2), particularly a top (7) of the housing (2), has operator control elements (9, 10), particularly foot switches, arranged on it, with particularly at least each slot (4a-4f) having an associated operator control element (10).

13. The musical instrument system as claimed in claim 12, wherein the operator control elements (10) can be used to retrieve preset programs and/or to individually activate, particularly control, the effects modules (19) that are inserted.

14. The musical instrument system as claimed in claim 12, wherein the operator control elements (9, 10) can be used to program the control electronics (6).

15. The musical instrument system as claimed in claim 1, wherein particularly the top (7) of the housing (2) has indicator elements (11, 12) arranged on it that can be actuated by means of the control electronics (6).

16. An effects module for a musical instrument system as claimed in claim 1 that has a plug-in card (20) that has a contact strip for introduction into a multipin connection of the musical instrument system.

17. The effects module as claimed in claim 16, wherein the contact strip comprises contacts for an operating voltage, a reference-ground potential, audio signals, control signals and MIDI signals.

18. The effects module as claimed in claim 16, wherein a side of the plug-in card (20) that is opposite the contact strip has a cover element (21) mounted on it that can be used to immobilize the effects module (19) in a housing of the musical instrument system.
